(19) United States
(12) Patent Application Publication
(10) Pub. No.: US 2025/0328644 A1
(43) Pub. Date: Oct. 23, 2025

(54) Ransomware Detecting Using Decoy Files

(71) Applicant: NetApp, Inc., San Jose, CA (US)

(72) Inventors: Arunkumar Gururajan, Sammamish, WA (US); Muneem Shahriar, Sunnyvale, CA (US); Mesfin Dema, Allen, TX (US); Phani Srikanth Bhavani Sankar, Hyderabad (IN)

(21) Appl. No.: 18/785,537

(22) Filed: Jul. 26, 2024

(30) Foreign Application Priority Data
Apr. 23, 2024 (IN) 202441032099

(51) Int. Cl. G06F 21/56

(52) U.S. Cl. CPC G06F 21/565; G06F 2221/034

(57) ABSTRACT

Disclosed herein are systems, methods, and software for the operation of a ransomware detection system. The ransomware detection system generates a decoy file based on characteristics of an existing file in a file system. The decoy file is effectively indistinguishable from the existing file from the perspective of the ransomware but contains simulated data rather than authentic data. The ransomware detection system identifies a location in the file system and deploys the decoy file to the location. The decoy is then monitored to detect changes by comparing a ground truth for the decoy file to the current state of the decoy file. The decoy file is checked for changes at a rate associated with the identified location. Where a change is detected, an alert is sent to a ransomware mitigation process, which initiates ransomware mitigation.

### TECHNICAL FIELD

Aspects of the disclosure are generally related to the field of computing hardware and software, and more specifically, ransomware detection and mitigation technology.

### BACKGROUND

Malicious actors use ransomware attacks to infect user devices and access file systems. A malicious actor encrypts the user's files so that the data they contain may no longer be accessed. The malicious actor, anticipating that at least some of the encrypted data is important to the user, demands a ransom in exchange for cryptographic keys that decrypt the files.

Solutions for detecting ransomware attacks cycle through the files in a file system to scan for ransomware. Ransomware is detected by scanning files for evidence of a ransomware attack, which requires that a portion of the attack is already underway before detection can be successfully performed. As a result, some portion of data is necessarily exposed to ransomware in order to successfully perform detection. Unfortunately, the exposed portion of data may already be encrypted and beyond a user's reach by the time detection occurs.

Further, the longer a ransomware attack goes on undetected, the greater the number of files at risk of encryption. Unless the user opts to pay the malicious actor for the encryption keys to the ransomed files, the encrypted data may be permanently lost. Cycling through the files in a file system to scan for ransomware creates periods where certain files are not scanned, during which the effects of a ransomware attack go unnoticed.

### SUMMARY

Disclosed herein are systems, methods, and software that detect ransomware by using decoy files. In various implementations, a ransomware detection system generates a decoy file based on characteristics of an existing file or files in a file system. In some implementations, the system may generate a prompt indicative of the one or more characteristics of the one or more files. The prompt is submitted to a generative artificial intelligence (GAI) to create the decoy file based on the one or more characteristics.

The ransomware detection system identifies a location in the file system at which to place the decoy file and places the decoy at the location. The decoy is then monitored to detect changes at a rate associated with the identified location. For example, certain locations may be monitored more frequently (or at a higher rate) than other locations, due to their sensitivity.

The ransomware detection system monitors the decoy file(s) for changes, the occurrence of which may indicate the presence and activity of ransomware, since the decoy file(s) would otherwise not change. Thus, in response to detecting a change, the system takes steps to mitigate the risk or impact of ransomware, such as by locking down access to the file system, restoring affected files, and the like. Beneficially, the ransomware detection system increases the likelihood that a ransomware attack was detected prior to any real files containing authentic data being encrypted by the ransomware attack.

This Summary introduces a selection of concepts in a simplified form that are further described below in the Technical Disclosure. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates a computing environment in an implementation.

FIG. 2 illustrates a ransomware detection process in an implementation.

FIG. 3 illustrates an operational sequence in an implementation.

FIG. 4A illustrates an operational scenario in an implementation.

FIG. 4B illustrates another operational scenario in an implementation.

FIG. 5 illustrates another computing environment in an implementation.

FIG. 6 illustrates another operational sequence in an implementation.

FIG. 7 illustrates another computing environment in an implementation.

FIG. 8 illustrates a computing system in an implementation.

### DETAILED DESCRIPTION

Disclosed herein are methods and apparatus for the operation of a ransomware detection system. The ransomware detection system generates a decoy file based on characteristics of an existing file or existing group of files in a file system. The ransomware detection system identifies a location in the file system at which to place the decoy file and deploys the decoy to the location. The decoy is then monitored to detect changes at a rate associated with the identified location. Where the ransomware detection system detects a change, an indication is sent to a ransomware mitigation process, where ransomware mitigation is initiated.

In some embodiments, the ransomware detection system generates the decoy file by first extracting one or more characteristics for one or more existing files in the file system. The ransomware detection system creates a prompt that includes the one or more extracted characteristics and instructions to generate a decoy file based on the characteristics. The ransomware detection system submits the prompt to a generative artificial intelligence (GAI) and, in response, receives the decoy file.

In some embodiments, the location in the file system is a folder in the file system. In such embodiments, identifying the location in the file system at which to place the decoy file is based on characteristics of the file system. In some of the embodiments, the characteristic of the file system is an identify of a most-recently-used folder or a folder corresponding to a list of most recently used files. In some embodiments, where the decoy is placed in a location associated with most-recently-used files, the ransomware detection system refreshes the decoy file to preserve the position of the decoy file relative to the other most-recently-used files.

In some embodiments, the ransomware detection system further generates multiple additional decoy files. The multiple additional decoy files are placed in a same location as the decoy file and each of the multiple additional decoy files are monitored for changes. Where the ransomware detection system detects a change for any of the additional decoy files, an indication is sent to a ransomware mitigation process, where ransomware mitigation is initiated.

In some embodiments, the ransomware detection system generates the decoy file based on changes made to an existing file since the execution of a most-recent snapshot of the existing file. In some of the embodiments, the changes made to the existing file since the most-recent snapshot are captured in a subsequent snapshot, while the decoy is refreshed based on any changes made to the existing file since the subsequent snapshot.

In some embodiments, the ransomware detection system initiates a ransomware mitigation process by identifying a ransomware attack vector and foreclosing the ransomware attack vector as a means to gain access to the file system.

Various embodiments of the present technology provide for a wide range of technical effects, advantages, and/or improvements to computing systems and components. For example, various embodiments may include one or more of the following technical effects, advantages, and/or improvements: 1) non-routine and unconventional dynamic implementation of decoy files in a ransomware detection system; and 2) non-routine and unconventional operations for evaluating the presence of ransomware in a file system.

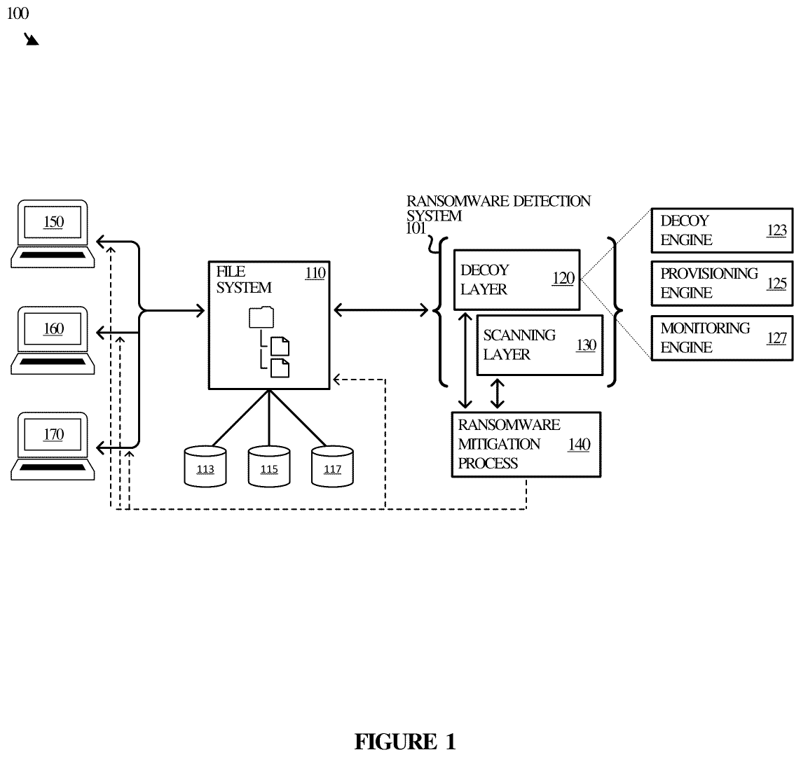

FIG. 1 illustrates a computing environment 100 in an implementation. Computing environment 100 includes file system 110, storage 113, storage 115, storage 117, ransomware detection system 101, ransomware mitigation process 140, user device 150, user device 160, and user device 170. Ransomware detection system 101 includes decoy layer 120 and scanning layer 130. Decoy layer 120 further includes decoy engine 123, provisioning engine 125, and monitoring engine 127.

Computing environment 100 is generally representative of any environment in which a ransomware detection system (e.g., ransomware detection system 101) is communicatively coupled with a file system (e.g., file system 110). Communication between the elements of computing environment 100 could be facilitated by a local area network, a wireless network, a wide area network, and the like.

File system 110 is generally representative of a network file system for organizing, managing, and accessing files across a number of networked computing devices (e.g., computing device 805) and various storage media. File system 110 makes accessible the existing files that may be targeted by ransomware attacks. File system 110 includes metadata for each file included therein, examples of which include a file name, a file type, a time of most recent revision, and the like.

Storage 113, storage 115, and storage 117 are generally representative of various data storage media with which file system 110 may be associated. Each of storage 113, storage 115, and storage 117 may respectively be direct attached storage, such as hard-disks or solid-state drives. Storage 113, storage 115, and storage 117 may also be network based storage such as network attached storage (NAS) or a storage area network (SAN). File system 110 governs access to each of storage 113, storage 115, and storage 117 and the data stored therein.

Decoy layer 120 generates decoy files, places the decoy files at an identified location in file system 110, monitors the decoy file for changes, and submits an alert to ransomware mitigation process 140 when a change is detected. Decoy layer 120 further includes decoy engine 123, provisioning engine 125, and monitoring engine 127.

Decoy engine 123 is generally representative of software, hardware, or firmware configured to generate decoy files. Decoy engine 123 generates the decoy file based on characteristics of one or more existing files in file system 110. Generating the decoy file based on characteristics of the one or more existing files allows the decoy file to disguise itself as one of the existing files. The ransomware, unable to distinguish between the existing files and the decoy file, treats the decoy file as if it were any other existing file and a target for attack. In some examples, a number of existing files are interrogated for a common characteristic, on which the generation of the decoy file is based.

Provisioning engine 125 is generally representative of software, hardware, or firmware configured to identify a location in file system 110 at which the decoy file is placed. Provisioning engine 125 identifies the location in file system 110 and places the decoy file at the identified location. Provisioning engine 125 places the decoy file at the identified location via a save process of the file system or a similar method. Provisioning engine 125 is configured to identify the location in the file system such that the likelihood that the decoy file is targeted by ransomware is maximized. For example, ransomware is more likely to target files with difficult to replace and unique data, such as user files. Placing the decoy file among, or at the beginning of, a list of user files increases the likelihood that the decoy file is targeted when compared to placing the decoy file among easily replaced files such as system files.

Monitoring engine 127 is generally representative of software, hardware, or firmware configured to monitor the decoy file to detect changes to the decoy file. To detect changes, monitoring engine 127 evaluates the metadata for the decoy file kept by file system 110. Because the decoy file is not visible to authorized users but only to ransomware, any indication of a modification shown in the metadata for the decoy file is evidence of a ransomware attack. Monitoring engine 127 checks the decoy file for changes at a rate associated with the identified location. A decoy deployed to a location with a higher risk of being targeted by ransomware can be scanned at a higher rate compared to the file scanning frequency afforded by cycling through the files in the file system.

Scanning layer 130 is generally representative of a ransomware detection processes that identifies the presence of ransomware for existing files in file system 110. Such techniques include textual analysis, semantic analysis, metadata analysis, and the like. Scanning layer 130 and decoy layer 120 operate simultaneously to detect ransomware attacks to existing files and decoy files of file system 110, respectively. In some cases, scanning layer 130 may only scan a file for evidence of ransomware in response to the file having been changed. In some other cases, scanning layer 130 scans files to check for evidence of ransomware on a predetermined schedule.

Ransomware mitigation process 140 is generally representative of software, hardware, or firmware processes for remedial action taken in response to detecting the presence of ransomware in file system 110. Ransomware mitigation process 140 may include blocking access to file system 110 from user device 150, user device 160, user device 170, disconnecting file system 110 from all remote network connections, file recovery actions, and the like.

User device 150, user device 160, and user device 170 are each generally representative of user terminals that facilitate access to file system 110. For example, where file system 110 contains internal documentation for a commercial enterprise, user device 150, user device 160, and user device 170 may each be administrators accessing and updating the internal documentation. Ransomware mitigation process 140 may respond to an indication that ransomware is present in file system 110 by access control for user device 150, user device 160, user device 170, or a combination thereof. Ransomware mitigation process 140 may also restore an effected file. Ransomware mitigation process 140 may further isolate file system 110 from network connections as part of a ransomware mitigation strategy.

In an example operation, decoy engine 123 generates a decoy file based on characteristics of an existing file or files of file system 110. The data representing the existing file is stored in storage 113, storage 115, and storage 117, or a combination thereof. Provisioning engine 125 identifies a location in file system 110 and places the decoy file at the location. Monitoring engine 127 checks the decoy file at a frequency based on risk characteristics of the location. Monitoring engine 127 detects a change to the decoy file via the decoy file metadata and submits an alert for the decoy file to ransomware detection process 140. In response, ransomware detection process 140 initiates ransomware mitigation. In the ongoing example, ransomware detection process 140 identifies the ransomware attack vector. For the sake of the example, the ransomware attack has accessed file system 110 via user device 150. Ransomware mitigation process 140 disconnects user device 150 from the network, thereby foreclosing the ransomware attack vector as a means to gain unauthorized access to file system 110.

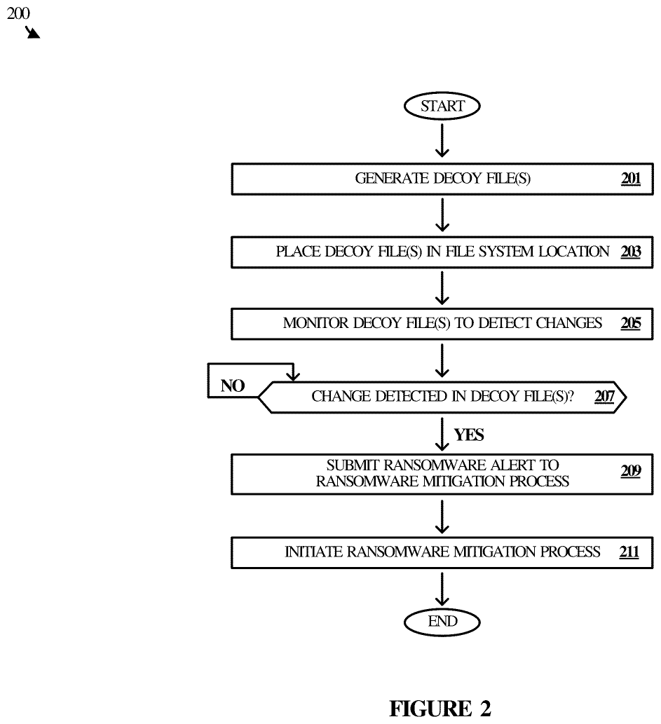

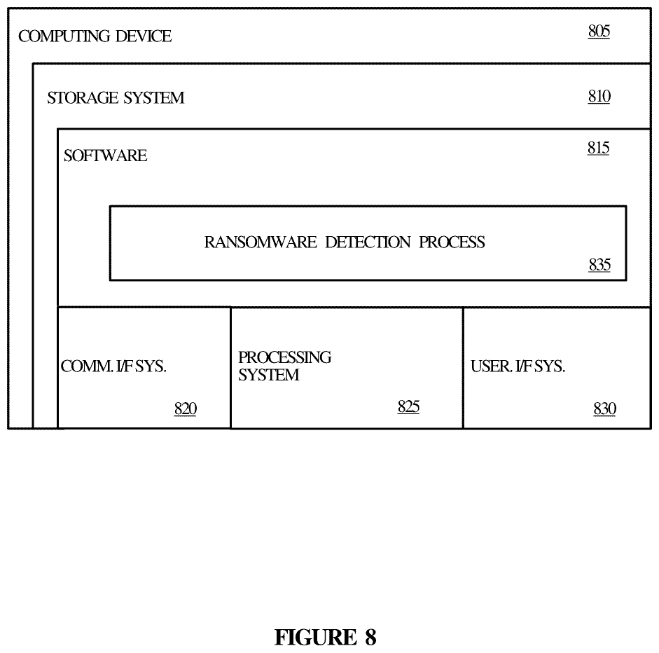

FIG. 2 illustrates ransomware detection process 200 in an implementation. Ransomware detection process 200 may be implemented in program instructions in the context of the software and/or firmware elements of decoy layer 120 of ransomware detection system 101. The program instructions, when executed by one or more processing devices of one or more computing systems (e.g., computing device 805 in FIG. 8), direct the one or more computing systems to operate as follows, referring parenthetically to the steps in FIG. 2, and in the singular to a computing device for the sake of clarity.

To begin, a decoy layer of a ransomware detection system generates one or more decoy files (step 201). A decoy engine of the decoy layer generates the decoy file based on one or more characteristics of one or more existing files in a file system. A provisioning engine of the decoy layer identifies a location in the file system at which the decoy file can be placed and places the decoy file at the location (step 203). The provisioning engine identifies the location in the file system such that the likelihood that the decoy file is targeted by ransomware is maximized. A monitoring engine of the decoy layer checks the decoy file to detect changes indicative of a ransomware attack (step 205). The monitoring engine checks the decoy file by evaluating metadata for the decoy file to identify evidence of change to the decoy file (step 207). Any change to the decoy file indicated by the decoy file metadata is evidence of a ransomware attack. Where the decoy file metadata does not indicate that the decoy file has been changed, the monitoring engine continues to check the decoy at a predetermined rate associated with the identified location. Where change is detected in the decoy file metadata, the monitoring engine submits an alert for the decoy file to a ransomware mitigation process (step 209). In response, the ransomware mitigation process initiates ransomware mitigation (step 211).

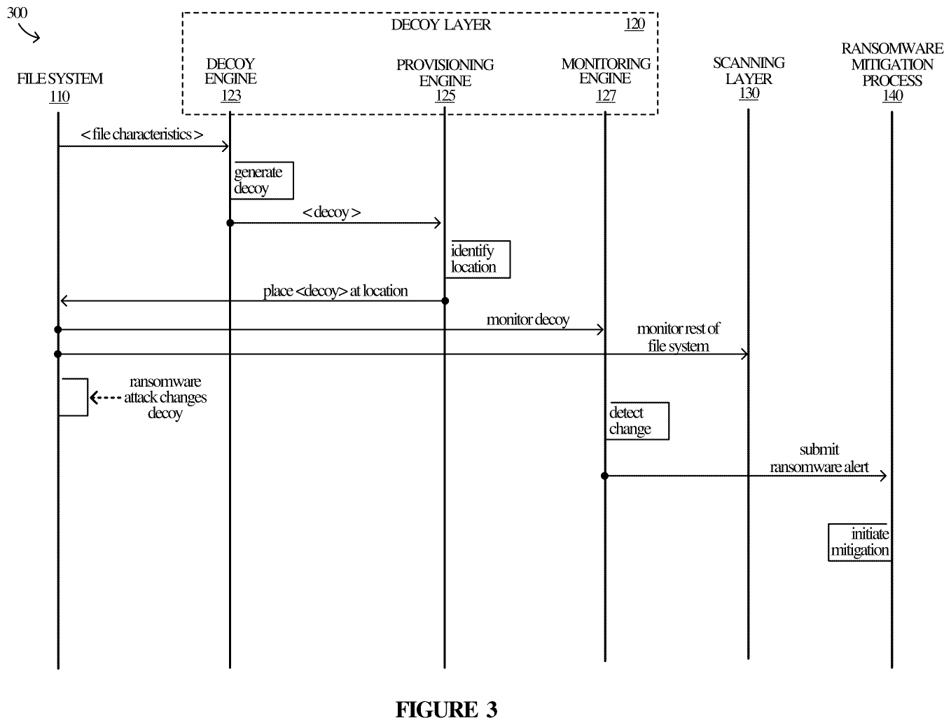

FIG. 3 illustrates an operational sequence 300 related to an application of ransomware detection process 200 in the context of computing environment 100 in an implementation.

To begin, file characteristics of an existing file or files in file system 110 are collected by decoy engine 123. Decoy engine 123 examines the one or more existing files by querying file system 110. Querying file system 110 allows decoy engine 123 to examine the content and metadata associated with the one or more existing files. Based on an examination of the content and metadata of the one or more existing files, decoy engine 123 generates the decoy file. In some examples, a natural language processing model is utilized as part of the examination of the content and metadata for the one or more existing files.

Decoy engine 123 generates a decoy file based on the characteristics. Decoy engine 123 evaluates the content and metadata of the one or more existing file and generates the decoy file to look as though it has similar content and has similar metadata to the one or more existing files. The decoy file may be generated based on content of the one or more existing files, metadata for one or more existing files, or a combination thereof.

Provisioning engine 125 receives the decoy file from decoy engine 123 in preparation for placing the decoy file in file system 110. Provisioning engine 125 may receive a copy of the decoy file, receive the decoy file by reference, or by other sufficient means.

Provisioning engine 125 identifies a location in file system 110 at which the decoy file is to be placed. Provisioning engine 125 is configured to identify the location in the file system such that the likelihood that the decoy file is targeted by ransomware is maximized. For example, ransomware is more likely to target files with difficult to replace and unique data, such as user files. Placing the decoy file among, or at the beginning of, a list of user files increases the likelihood that the decoy file is targeted when compared to placing the decoy file among easily replaced files such as system files.

Provisioning engine 125 then places the decoy file at the identified location in file system 110. Provisioning engine 125 places the decoy file at the identified location via a save file process of the file system or a similar method.

Monitoring engine 127 monitors the decoy to detect any changes. Until a change is detected in the decoy file, monitoring engine 127 continues checking the decoy file. Monitoring engine 127 checks the metadata for the decoy file to determine if the decoy file has been changed and is therefore experiencing a ransomware attack. In some examples, monitoring engine 127 directly checks the decoy file metadata, while in other examples, a different service or engine monitors the decoy file and reports to monitoring engine 127.

Scanning layer 130 monitors the existing files of the file system to detect ransomware. The process for monitoring the existing files of the file system and the process for monitoring a decoy file are the same.

A ransomware attack accesses the decoy file and begins an encryption process, resulting in a change to the decoy file. The ransomware accesses the decoy file via file system 110 and begins the encryption process by editing the content of the decoy file. Encrypting the decoy file by editing its content results in cognizable changes to both the content and the metadata of the decoy file.

Monitoring engine 127 checks the decoy file to detect changes. Monitoring engine 127 checks the metadata for the decoy file to determine the state of the decoy file. Monitoring engine 127 continually checks the metadata for the decoy file until a time when the metadata indicates the decoy file has been changed. The frequency that monitoring engine 127 checks decoy file metadata can be tailored based on a degree of risk associated with the location in the file system at which the decoy is placed.

Once a change to the decoy file is detected, monitoring engine 127 submits an alert for the decoy file to ransomware mitigation process 140. In response, ransomware mitigation process 140 initiates ransomware mitigation. Ransomware mitigation may include access control, file restoration, and the like.

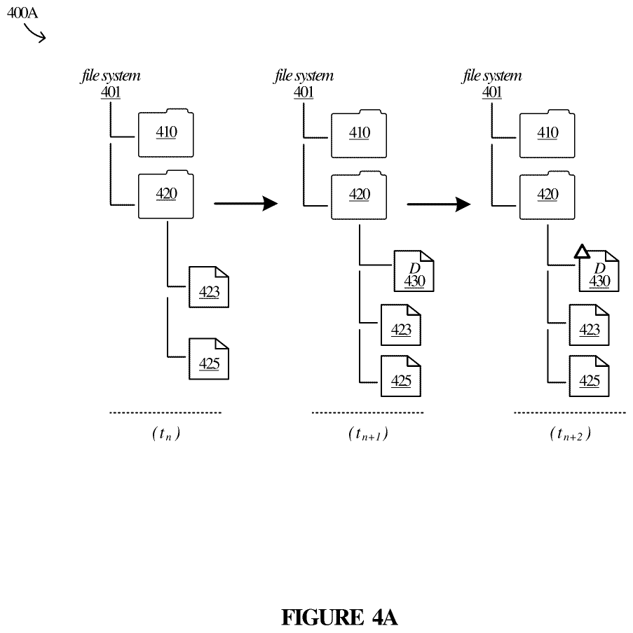

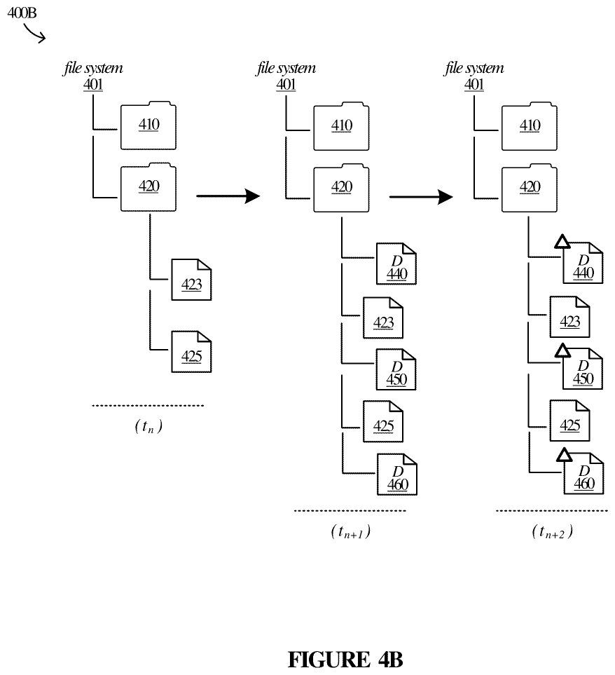

FIG. 4A illustrates an operational scenario 400A related to an application of ransomware detection process 200 in the context of computing environment 100 in an implementation. Operational scenario 400A includes stage tₙ, stage tₙ₊₁, and stage tₙ₊₂. Stage tₙ, stage tₙ₊₁, and stage tₙ₊₂ are illustrative of a file system at successive moments in time. The elements of Stage tₙ are included in stage tₙ₊₁ and stage tₙ₊₂ along with additional elements and element states added or updated at each successive moment in time.

Stage tₙ includes file system 401. File system 401 is similar to file system 110, which is described in greater detail in the associated text to FIG. 1. File system 401 includes folder 410 and folder 420. Folder 420 further includes file 423 and file 425. Folder 410 and folder 420 are generally representative of data storage structures capable of storing groups of files. File 423 and file 425 are generally representative of existing files on file system 401. Prior to stage tₙ₊₁, no decoy files are present in file system 401.

At stage tₙ₊₁, decoy file 430 has been generated and placed among file 423 and file 425. Decoy file 430 is configured to be effectively indistinguishable from the existing files of file system 401 represented by file 423 and file 425. Decoy file 430 is placed in file system 401 such that the likelihood of ransomware targeting decoy file 430 is maximized. Here, decoy file 430 is placed first in folder 420, increasing the likelihood that ransomware attacks decoy file 430 before file 423 and file 425. At stage tₙ₊₂, decoy file 430 has been changed. The changed state of decoy file 430 at stage tₙ₊₂ is illustrated by decoy file 430 having a delta symbol.

FIG. 4B illustrates another operational scenario related to an application of ransomware detection process 200 in the context of computing environment 100 in an implementation, represented by scenario 400B. Scenario 400B includes stage tₙ, stage tₙ₊₁, and stage tₙ₊₂. Stage tₙ, stage tₙ₊₁, and stage tₙ₊₂ are illustrative of a file system at successive moments in time. The elements of Stage tₙ are included in stage tₙ₊₁ and stage tₙ₊₂ along with additional elements and element states added or updated at each successive moment in time.

Stage tₙ includes file system 401. File system 401 is similar to file system 110, which is described in greater detail in the associated text to FIG. 1. File system 401 includes folder 410 and folder 420. Folder 420 further includes file 423 and file 425. Folder 410 and folder 420 are generally representative of data storage structures capable of storing groups of files. File 423 and file 425 are generally representative of existing files on file system 401. Prior to stage tₙ₊₁, no decoy files are present in file system 401.

At stage tₙ₊₁, decoy file 440, decoy file 450, and decoy file 460 have been generated and placed among file 423 and file 425. Decoy file 440, decoy file 450, and decoy file 460 are configured to be effectively indistinguishable from the existing files of file system 401 represented by file 423 and file 425. Decoy file 440, decoy file 450, and decoy file 460 are placed in file system 401 such that the likelihood of ransomware attack to each of decoy file 440, decoy file 450, and decoy file 460 is maximized. In some examples, maximizing the likelihood of a ransomware attack to each of decoy file 440, decoy file 450, and decoy file 460 is carried out by placing decoy file 440, decoy file 450, and decoy file 460 in a similar location. In other examples, maximizing the likelihood of a ransomware attack to each of decoy file 440, decoy file 450, and decoy file 460 is carried out by placing decoy file 440, decoy file 450, and decoy file 460 in different locations in the relevant parent folder or different locations in file system 401 generally. Here, decoy file 430 is placed first in folder 420, decoy file 450 is placed in folder 420 between file 423 and file 425, and decoy file 460 is placed last in folder 420. At stage tₙ₊₂, each of decoy file 440, decoy file 450, and decoy file 460 have been changed. The changed state of each of decoy file 440, decoy file 450, and decoy file 460 at stage tₙ₊₂ is illustrated by each of decoy file 440, decoy file 450, and decoy file 460 having a delta symbol. In some examples, one of decoy file 440, decoy file 450, and decoy file 460 has a change detected therein, while in other examples two or more of decoy file 440, decoy file 450, and decoy file 460 have a change detected therein.

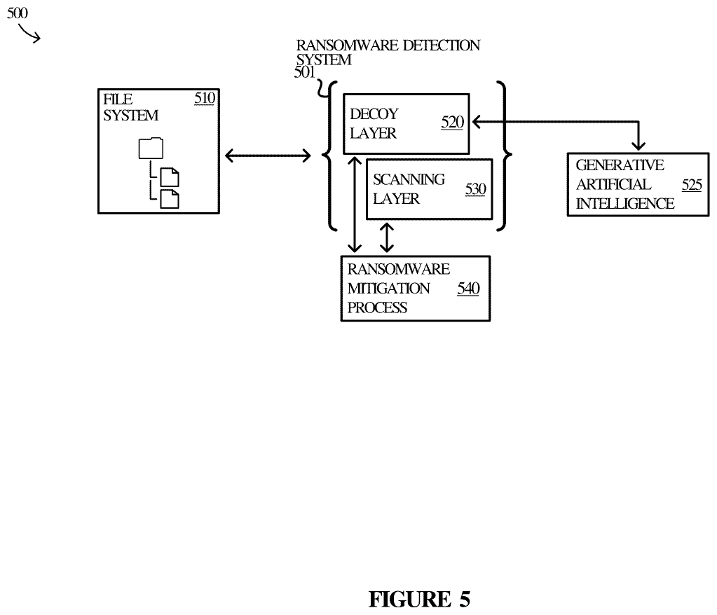

FIG. 5 illustrates another computing environment in an implementation, represented by environment 500. Environment 500 includes file system 510, ransomware detection system 501, generative artificial intelligence (GAI) 525, and ransomware mitigation process 540. Ransomware detection system 501 further includes decoy layer 520 and scanning layer 530.

Environment 500 is generally representative of any environment in which a ransomware detection system (e.g., ransomware detection system 501) is communicatively coupled with a file system (e.g., file system 510). Communication between the elements of environment 500 could be facilitated by a local area network, a wireless network, a wide area network, and the like.

File system 510 is generally representative of a network file system for organizing, managing, and accessing files across a number of networked computing devices (e.g., computing device 805) and various storage media. File system 510 makes accessible the existing files that may be targeted by ransomware attacks. File system 510 includes metadata for each file included therein, examples of which include a file name, a file type, a time of most recent revision, and the like. In an example, file system 510 is a local drive storing a number of word processor files. In another example, file system 510 is distributed cloud storage containing personally identifiable health information forms.

Ransomware detection system 501 is representative of a ransomware detection system including both decoy layer 520 and scanning layer 530. Ransomware detection system 501 is configured to detect ransomware in decoy files via decoy layer 520 and to detect ransomware in existing files of file system 510 via scanning layer 530.

Decoy layer 520 generates decoy files, places the decoy files at an identified location in file system 510, monitors the decoy file for changes, and submits an alert for the decoy file to ransomware mitigation process 540 when a change is detected. To generate decoy files, decoy layer 520 extracts file characteristics from one or more existing files of file system 510. Decoy layer 520 creates a prompt that includes the extracted characteristics and instructions to generate a decoy file based on the characteristics. Decoy layer 520 submits the prompt to generative artificial intelligence (GAI) 525 and, in response, receives the decoy file.

Scanning layer 530 is generally representative of a ransomware detection processes that identifies the presence of ransomware for existing files in file system 510. Such techniques include textual analysis, semantic analysis, metadata analysis, and the like. Scanning layer 530 and decoy layer 520 operate simultaneously to detect ransomware attacks to existing files and decoy files of file system 510, respectively.

Ransomware mitigation process 540 is generally representative of hardware, software, or firmware that offers ransomware mitigation. Upon receiving an alert from decoy layer 520 or scanning layer 530, ransomware mitigation process 540 initiates ransomware mitigation.

File characteristics from a file stored in file system 510 are extracted and included in a prompt. The prompt instructs GAI 525 to generate decoy files based on the extracted characteristics. GAI 525 receives the prompt from decoy layer 520 and, in response, returns a decoy file generated with respect to the file characteristics included in the prompt. Decoy layer 520 places the decoy file in an identified location in file system 510 and monitors the decoy file for changes. In response to the monitoring identifying changes to the decoy file via an analysis of the decoy file metadata, decoy layer 520 sends an alert to ransomware mitigation process 540. Ransomware mitigation process 540 then initiates ransomware mitigation.

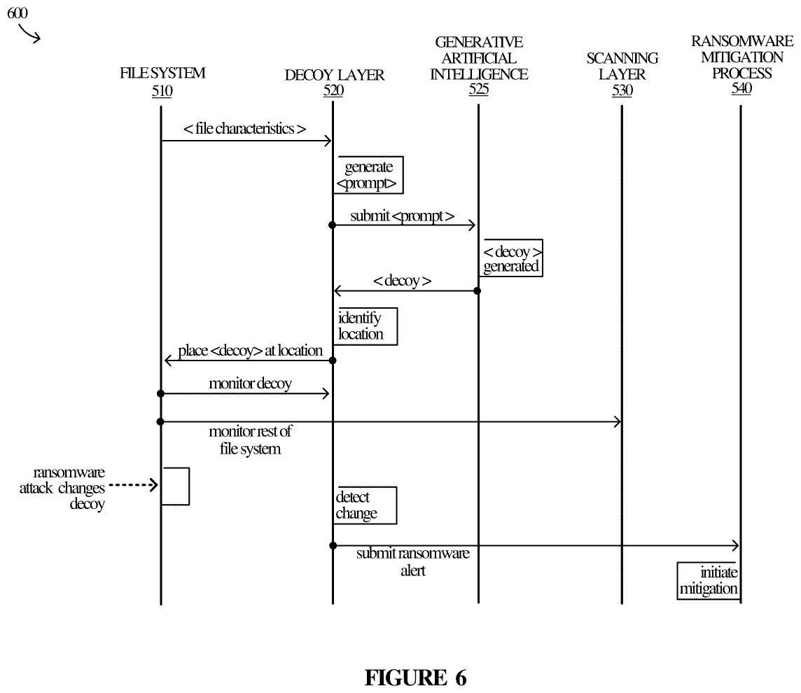

FIG. 6 illustrates another operational sequence of an application of ransomware detection process 200 in the context of environment 500 in an implementation, represented by sequence 600. Sequence 600 includes file system 510, decoy layer 520, scanning layer 530, GAI 525, and ransomware mitigation process 540. File system 510, decoy layer 520, scanning layer 530, GAI 525, and ransomware mitigation process 540 are the same as file system 510, decoy layer 520, scanning layer 530, GAI 525, and ransomware mitigation process 540 of FIG. 5, each of which are described in greater detail in the associated text to FIG. 5.

To begin, file characteristics of an existing file or files in file system 110 are collected by decoy layer 520. Decoy layer 520 examines the one or more existing files by querying file system 510. Querying file system 510 allows decoy layer 520 to examine the content and metadata associated with the one or more existing files. Based on an examination of the content and metadata of the one or more existing files, decoy layer 520 generates the decoy file. In some examples, a natural language processing model is utilized as part of the examination of the content and metadata for the one or more existing files.

Decoy layer 520 generates a prompt that includes the extracted file characteristics and instructions to create a decoy file based on the file characteristics. The prompt is submitted to GAI 525, which responds by generating a decoy file and returning the decoy file to decoy layer 520.

Decoy layer 520 receives the decoy file from GAI 525 in preparation for placing the decoy file in file system 110. Decoy layer 520 may receive a copy of the decoy file, receive the decoy file by reference, or by other sufficient means.

Decoy layer 520 identifies a location in file system 510 at which the decoy file is to be placed. Decoy layer 520 is configured to identify the location in the file system such that the likelihood that the decoy file is targeted by ransomware is maximized. For example, ransomware is more likely to target files with difficult to replace and unique data, such as user files. Placing the decoy file among, or at the beginning of, a list of user files increases the likelihood that the decoy file is targeted when compared to placing the decoy file among easily replaced files such as system files.

Decoy layer 520 then places the decoy file at the identified location in file system 510. Decoy layer 520 places the decoy file at the identified location via a save file process of the file system or a similar method.

Decoy layer 520 monitors the decoy file to detect changes indicative of a ransomware attack. Decoy layer 520 checks the metadata for the decoy file to determine if the decoy file has been changed and is therefore experiencing a ransomware attack. In some examples, decoy layer directly checks the decoy file metadata, while in other examples, a different service or engine monitors the decoy file and reports to decoy layer 520.

Scanning layer 130 monitors the existing files of the file system to detect ransomware. The process for monitoring the existing files of the file system and the process for monitoring a decoy file are the same.

A ransomware attack accesses the decoy file and begins an encryption process, resulting in a change to the decoy file. The ransomware accesses the decoy file via file system 510 and begins the encryption process by editing the content of the decoy file. Encrypting the decoy file by editing its content results in cognizable changes to both the content and the metadata of the decoy file.

Decoy layer 520 checks the metadata for the decoy file to determine the state of the decoy file. Decoy layer 520 continually checks the metadata for the decoy file until such a time when the metadata indicates the decoy file has been changed. The frequency that decoy layer 520 checks decoy file metadata can be tailored based on a degree of risk associated with the location in the file system at which the decoy is placed.

Once a change to the decoy file is detected, decoy layer 520 submits an alert for the decoy file to ransomware mitigation process 540. In response, ransomware mitigation process 540 initiates ransomware mitigation.

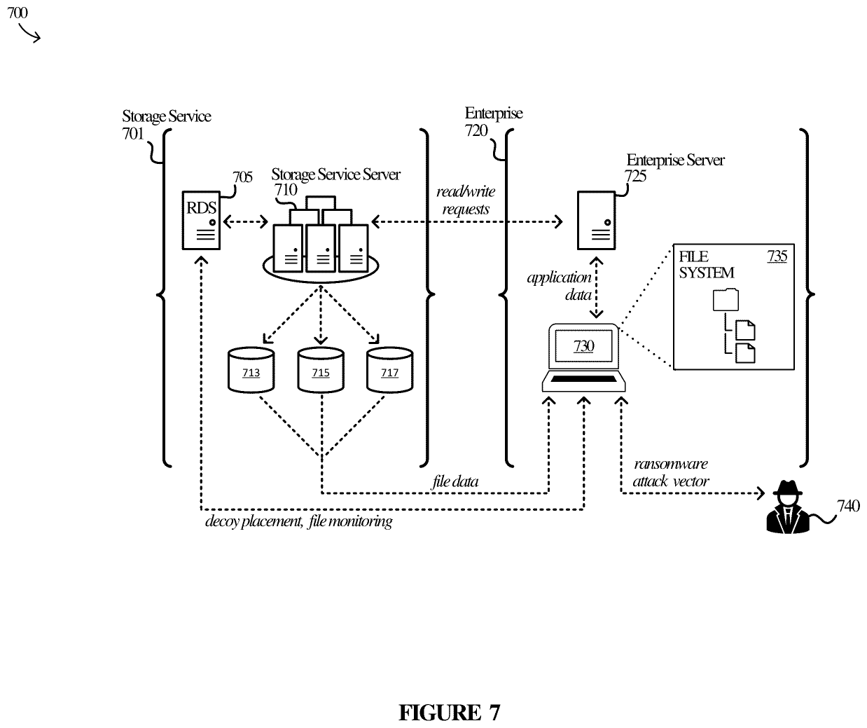

FIG. 7 illustrates another computing environment in an implementation, represented by environment 700. Environment 700 includes storage service 701, enterprise 720, and attacker 740. Storage service 701 further includes ransomware detection system 705, storage service server 710, storage 713, storage 715, and storage 717. Enterprise 720 further includes enterprise server 725, and user device 730. User device 730 further includes file system 735.

Storage service 701 is generally representative of a data management service. One example of a data management service is ONTAP data management software offered by NetApp. Storage service 701 could be an on-premises resource or could also be a cloud resource. Ransomware detection system 705 is generally representative of software, hardware, or firmware configured to provide a ransomware detection process (e.g., ransomware detection process 200). Ransomware detection system 705 is configured to generate a decoy file based on an existing file in file system 735. Ransomware detection system 705 acquires the characteristics via storage service server 710. Ransomware detection system 705 identifies a location in file system 735 and places the decoy file at the location. Ransomware detection system 705 then monitors the decoy file for changes by evaluating metadata for the decoy file. In response to detecting a change to the decoy file via the decoy file metadata, ransomware detection system 705 sends an alert to a ransomware mitigation process, an example of which is given by ransomware mitigation process 540.

Storage service server 710 is generally representative of computational resources configured to provide a data management service (e.g., storage service 701). Storage service server 710 is configured to interface with various storage media of storage service 701 and with one or more enterprise servers, such as enterprise server 725. Storage 713, storage 715, and storage 717 are generally representative of various data storage media to which storage service server 710 may be coupled. Each of storage 713, storage 715, and storage 717 may respectively be direct attached storage, such as hard-disks or solid-state drives. Storage 713, storage 715, and storage 717 may also be network based storage such as network attached storage (NAS) or a storage area network (SAN).

Enterprise 720 is generally representative of an enterprise generating application data and utilizing a storage service, such as storage service 701. Enterprise server 725 is generally representative of computational resources configured to engage with a user device, such as user device 730, and storage service server 710 to facilitate an enterprise application. Enterprise server 725 is configured to interface with one or more user devices, such as user device 730, and with storage service servers, such as storage service server 710. User device 730 is generally representative of a computing device configured to run an enterprise application. File system 735 is generally representative of a system for organizing, managing, and accessing the files and directories on a computing device's (e.g., computing device 805) solid-state drive, hard-disk drive, or other storage media. File system 735 makes accessible the existing files that may be targeted by ransomware attacks. The generation of decoy files is carried out based on the existing files stored in file system 735.

Attacker 740 is generally representative of a malicious actor intending to invade a file system to execute ransomware for nefarious purposes. Attacker 740 may gain access to file system 735 by a variety of means, such as phishing techniques and the like.

In operation, ransomware detection system 705 generates a decoy file based on file characteristics of a file in file system 735. The decoy file is placed in file system 735 in a location selected to increase the likelihood that the decoy file is targeted. Attacker 740 uses a ransomware attack vector via user device 730 to gain access to file system 735. With access to file system 735, attacker 740 may begin encrypting files via storage service 701. Ransomware detection system 705 monitors the decoy file and recognizes the changes to decoy file metadata that occur as a result of the decoy file being targeted by the ransomware. In response to detecting the changes, ransomware detection system 705 initiates ransomware mitigation. The ransomware mitigation process may include governing access to file system 735, blocking specific devices from accessing file system 735, temporarily disconnecting file system 735 from any network connections, and the like.

FIG. 8 illustrates computing device 805, which is representative of any system or collection of systems in which the various applications, processes, services, and scenarios disclosed herein may be implemented. Examples of computing device 805 include, but are not limited to server computers, web servers, cloud computing platforms, and data center equipment, as well as any other type of physical or virtual server machine, container, and any variation or combination thereof. (In some examples, computing device 805 may also be representative of desktop and laptop computers, tablet computers, and the like.)

Computing device 805 may be implemented as a single apparatus, system, or device or may be implemented in a distributed manner as multiple apparatuses, systems, or devices. Computing device 805 includes, but is not limited to, processing system 825, storage system 810, software 815, communication interface system 820, and user interface system 830. Processing system 825 is operatively coupled with storage system 810, communication interface system 820, and user interface system 830.

Processing system 825 loads and executes software 815 from storage system 810. Software 815 includes and implements ransomware detection process 835, which is representative of the processes discussed with respect to the preceding Figures, such as ransomware detection process 200. When executed by processing system 825, software 815 directs processing system 825 to operate as described herein for at least the various processes, operational scenarios, and sequences discussed in the foregoing implementations. Computing device 805 may optionally include additional devices, features, or functionality not discussed for purposes of brevity.

Referring still to FIG. 8, processing system 825 may include a micro-processor and other circuitry that retrieves and executes software 815 from storage system 810. Processing system 825 may be implemented within a single processing device but may also be distributed across multiple processing devices or sub-systems that cooperate in executing program instructions. Examples of processing system 825 include general purpose central processing units, microcontroller units, graphical processing units, application specific processors, integrated circuits, application specific integrated circuits, and logic devices, as well as any other type of processing device, combinations, or variations thereof.

Storage system 810 may comprise any computer readable storage media readable by processing system 825 and capable of storing software 815. Storage system 810 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 810 may be implemented as a single storage device but may also be implemented across multiple storage devices or sub-systems co-located or distributed relative to each other. Storage system 810 may comprise additional elements, such as a controller, capable of communicating with processing system 825 or possibly other systems.

Software 815 (including ransomware detection process 835) may be implemented in program instructions and among other functions may, when executed by processing system 825, direct processing system 825 to operate as described with respect to the various operational scenarios, sequences, and processes illustrated herein. For example, software 815 may include program instructions for implementing ransomware detection processes and procedures as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 815 may include additional processes, programs, or components, such as operating system software, virtualization software, or other application software. Software 815 may also comprise firmware or some other form of machine-readable processing instructions executable by processing system 825.

In general, software 815, when loaded into processing system 825 and executed, transforms a suitable apparatus, system, or device (of which computing device 805 is representative) overall from a general-purpose computing system into a special-purpose computing system customized to support a ransomware detection system as described herein. Indeed, encoding software 815 on storage system 810 may transform the physical structure of storage system 810. The specific transformation of the physical structure may depend on various factors in different implementations of this description. Examples of such factors may include, but are not limited to, the technology used to implement the storage media of storage system 810 and whether the computer-storage media are characterized as primary or secondary storage, as well as other factors.

For example, if the computer readable storage media are implemented as semiconductor-based memory, software 815 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 820 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 805 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method of operating a ransomware detection system, the method comprising:
generating a decoy file based on one or more characteristics of one or more files in a file system;
identifying a location in the file system based at which to place the decoy file;
placing the decoy file at the identified location in the file system;
monitoring the decoy file at a rate associated with the identified location to detect changes to the decoy file; and
in response to detecting a change to the decoy file, initiating a ransomware mitigation process.

2. The method of claim 1, wherein the generating the decoy file comprises:
extracting one or more characteristics for the one or more files;
generating a prompt indicative of the one or more characteristics of the one or more files and tasking a generative artificial intelligence (GAI) to receive the prompt and create the decoy file based on the one or more characteristics; and
receiving the decoy file from the GAI.

3. The method of claim 1, wherein:
the location in the file system comprises a folder in the file system; and
wherein identifying the location comprises identifying the location based on one or more characteristics of the file system.

4. The method of claim 3, wherein the one or more characteristics of the file system comprises an identity of a most-recently-used folder or an identity of a folder corresponding to a list of most recently used files.

5. The method of claim 1, further comprising refreshing the decoy file to preserve a position of the decoy file in a list of most-recently-used files.

6. The method of claim 1, further comprising:
generating multiple additional decoy files;
placing the additional decoy files in a same location as the decoy file;
monitoring the additional decoy files to detect changes to any of the additional decoy files; and
in response to detecting a change to any of additional decoy files, initiating a ransomware mitigation process.

7. The method of claim 1, wherein generating the decoy file comprises:
generating the decoy file based on changes made to an existing file since a most-recent snapshot taken of the existing file.

8. The method of claim 7, further comprising:
capturing the changes made to the existing file in a subsequent snapshot of the existing file; and
refreshing the decoy file based on subsequent changes made to the existing file since the subsequent snapshot.

9. The method of claim 1, wherein initiating the ransomware mitigation process comprises identifying a ransomware attack vector and foreclosing the ransomware attack vector as an entry point to access to the file system.

10. A ransomware detection system, the system comprising:
a decoy engine configured to generate a decoy file based on one or more characteristics of one or more files in a file system;
a provisioning engine configured to identify a location in the file system based at which to place the decoy file and place the decoy file at the identified location in the file system; and
a monitoring engine configured to detect changes to the decoy file at a rate associated with the identified location to detect changes to the decoy file and, in response to detecting a change to the decoy file, initiate a ransomware mitigation process.

11. A computing apparatus comprising:
one or more computer readable storage media;
one or more processors operatively coupled with the one or more computer readable storage media; and
a ransomware detection system comprising program instructions stored on the one or more computer readable storage media, wherein the program instructions, when executed by the one or more processors, direct the computing apparatus to at least:
generate a decoy file based on one or more characteristics of one or more files in a file system;
identify a location in the file system based at which to place the decoy file;
place the decoy file at the identified location in the file system; and
monitor the decoy file at a rate associated with the identified location to detect changes to the decoy file.

12. The computing apparatus of claim 11, wherein the program instructions further direct the computing apparatus to, in response to detecting a change to the decoy file, initiate a ransomware mitigation process.

13. The computing apparatus of claim 11, wherein the program instructions directing the computing apparatus to generate the decoy file comprises instructions to:
extract one or more characteristics for the one or more files;
generate a prompt indicative of the one or more characteristics of the one or more files and tasking a generative artificial intelligence (GAI) to receive the prompt and create the decoy file based on the one or more characteristics; and
receive the decoy file from the GAI.

14. The computing apparatus of claim 11, wherein:
the location in the file system comprises a folder in the file system; and
wherein the program instructions directing the computing apparatus to identify the location comprises instructions to identify the location based on characteristics of the file system.

15. The computing apparatus of claim 13, wherein the characteristic of the file system comprises one of an identity of a most-recently-used folder or a folder corresponding to a list of most recently used files.

16. The computing apparatus of claim 11, further comprising program instructions directing the computing apparatus to refresh the decoy file to preserve a position of the decoy file in a list of most-recently-used files.

17. The computing apparatus of claim 11, further comprising program instructions directing the computing apparatus to:
generate multiple additional decoy files;
place the additional decoy files in a same location as the decoy file;
monitor the additional decoy files to detect changes to any of the additional decoy files; and
in response to detecting a change to any of additional decoy files, initiating a ransomware mitigation process.

18. The computing apparatus of claim 11, wherein the program instructions directing the computing apparatus to generate the decoy file comprises instructions to:
generate the decoy file based on changes made to an existing file since a most-recent snapshot taken of the existing file.

19. The computing apparatus of claim 17, further comprising program instructions directing the computing apparatus to:
capture the changes made to one or more files in a subsequent snapshot of the one or more files; and
refresh the decoy file based on subsequent changes made to the one or more files since the subsequent snapshot.

20. The computing apparatus of claim 11, further comprising program instructions directing the computing apparatus to:
identify a ransomware attack vector; and
foreclose the ransomware attack vector as an entry point to access to the file system.
